(19) United States
(12) Patent Application Publication
(10) Pub. No.: US 2013/0346292 A1
(43) Pub. Date: Dec. 26, 2013

(54) DYNAMIC CHECK IMAGE GENERATION

(71) Applicants: Joohyung CHUNG, Charlotte, NC (US); Srinivasa V. Prasad KRISHNAMSETTY, Charlotte, NC (US); Steven T. NOE, Charlotte, NC (US)

(72) Inventors: Joohyung CHUNG, Charlotte, NC (US); Srinivasa V. Prasad KRISHNAMSETTY, Charlotte, NC (US); Steven T. NOE, Charlotte, NC (US)

(73) Assignee: INTERNATIONAL BUSINESS MACHINES CORPORATION, Armonk, NY (US)

(21) Appl. No.: 13/531,539

(22) Filed: Jun. 23, 2012

(51) Int. Cl. G06Q 20/22

(52) U.S. Cl. 705/39

(57) ABSTRACT

A dynamic check generation during the payment creation process includes: receiving a new payment item; in response to receiving the new payment item, determining whether information for a new check image generation for the new payment item is received; in response to determining that the information for the new check image generation for the new payment item is received, generating a check image using the new check image generation information; and displaying the new payment item within the check image. When a request to refresh the check image is received, modified information for the new check image generation for the new payment item is obtained, a modified check image is generated using the modified information, and the payment item is displayed within the modified check image.

### BACKGROUND

Check payment or transaction correction and reconciliation applications are commonly used by users. Such applications display an electronic check image when the user enters a payment item, which includes payment attributes, such as the account number, bank routing number, check number, and any other relevant information. However, the applications do not allow the user to specify or update the payment attributes when the payment item is entered. Instead, these applications may display an unavailable-check image.

### SUMMARY

According to one embodiment of the present invention, a method implemented by a processor of computing device, comprises: receiving, by the processor, a new payment item; in response to receiving the new payment item, determining, by the processor, whether information for a new check image generation for the new payment item is received; in response to determining that the information for the new check image generation for the new payment item is received, generating a check image using the new check image generation information; and displaying the new payment item within the check image.

In one aspect of the embodiment of the present invention, the determining whether the information for the new check image generation for the new payment item is received and the generating of the check image using the new check image generation information comprise: determining whether a check image generation class is configured; in response to determining that the check image generation class is configured, obtaining one or more payment attributes for the new payment item using getter functions associated with the check image generation class; generating the check image using the payment attributes; and displaying the new payment item within the check image.

In one aspect of the embodiment of the present invention, the method comprises: determining a request to refresh the check image is received; in response to determining that the request to refresh the check image is received, obtaining one or more modified payment attributes for the new payment item using the getter functions associated with the check image generation class; generating a modified check image using the modified payment attributes; and displaying the payment item within the modified check image.

In one aspect of the embodiment of the present invention, the determining whether the information for the new check image generation for the new payment item is received comprises: determining whether a static check image for the new payment item is indicated; in response to determining that the static check image for the new payment item is indicated, retrieving the static check image; and displaying the new payment item within the static check image.

In one aspect of the embodiment of the present invention, the determining whether the information for the new check image generation for the new payment item is received comprises: determining whether a check image generation class is configured; in response to determining that the check image generation class is not configured, retrieving a default check image; and displaying the new payment item within the default check image.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system for dynamic check image generation according to the present invention.

FIG. 2 is a flowchart illustrating an embodiment of a method for dynamic check image generation according to the present invention.

FIG. 3 is a flowchart illustrating in more detail an embodiment of the method for dynamic check generation according to the present invention.

FIG. 4 illustrates an example screen that is generated according to an embodiment of the present invention.

FIG. 5 illustrates a pseudo code segment according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

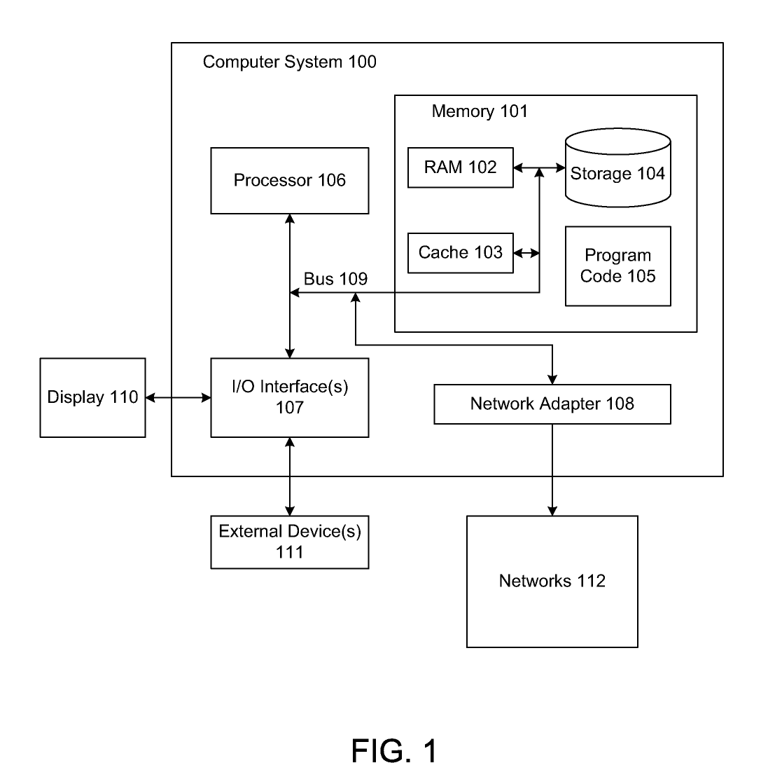

FIG. 1 illustrates an embodiment of a system for dynamic check image generation according to the present invention. The computer system 100 is operationally coupled to a processor or processing units 106, a memory 101, and a bus 109 that couples various system components, including the memory 101 to the processor 106. The bus 109 represents one or more of any of several types of bus structure, including a memory bus or memory controller, a peripheral bus, an accelerated graphics port, and a processor or local bus using any of a variety of bus architectures. The memory 101 may include computer readable media in the form of volatile memory, such as random access memory (RAM) 102 or cache memory 103, or non-volatile storage media 104. The memory 101 may include at least one program product having a set of at least one program code module 105 that are configured to carry out the functions of embodiment of the present invention when executed by the processor 106. The computer system 100 may also communicate with one or more external devices 111, such as a display 24, via I/O interfaces 107. The computer system 100 may communicate with one or more networks 112 via network adapter 108.

Embodiments of the present invention provide a dynamic approach to check image generation, where check images are displayed dynamically based on payment attributes entered by a user during the payment creation process.

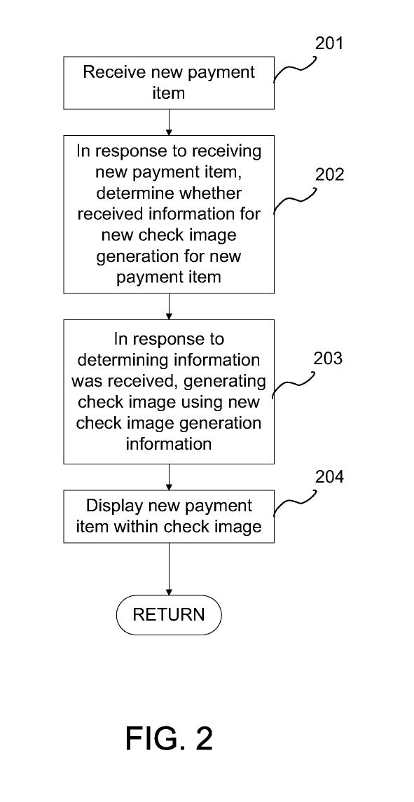

FIG. 2 is a flowchart illustrating an embodiment of a method for dynamic check image generation according to the present invention. The method, via the processor 106, first receives a new payment item from a user (201). In response to receiving the new payment item, the method, via the processor 106, determines whether information for a new check image generation for the new payment item is received from user (202). The information for the new check image generation may include an account number, an amount, a bank routing number, and any other information relevant to the payment transaction. In response to determining that the information for the new check image generation is received, the method, via the processor 106, generates a check image using the new check image generation information (203). The new payment item is then displayed within the check image (204).

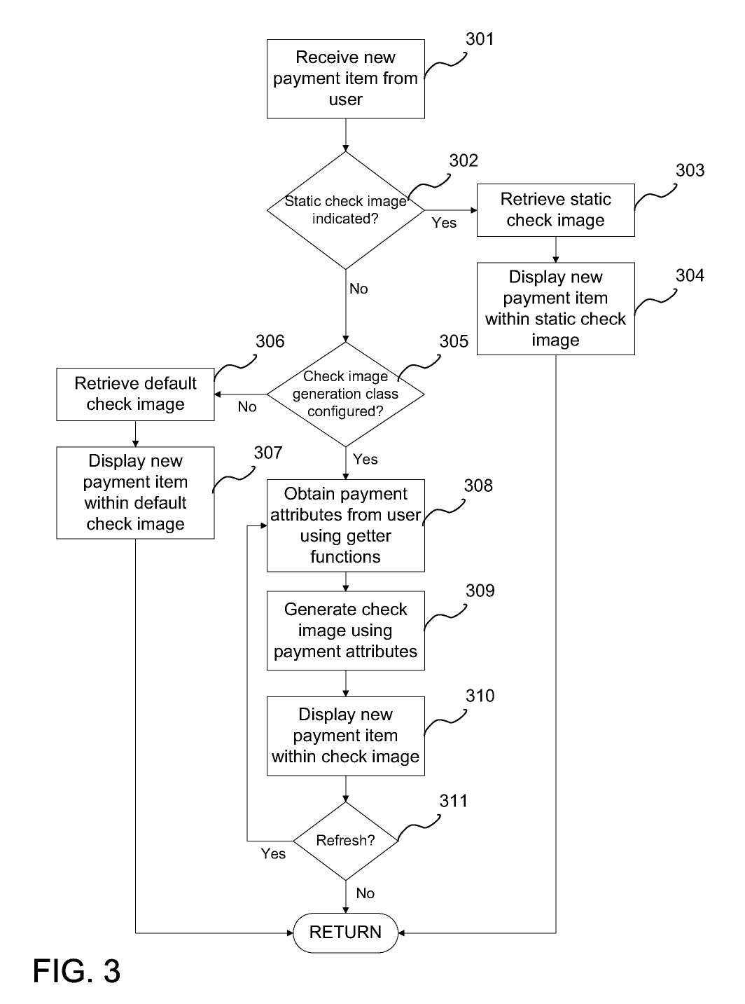

In one embodiment of the present invention, the system provides two ways to associate a check image to a new payment item while the payment is being created: associating a preconfigured static check image to the payment item; and dynamically generating a check image using payment attributes entered by the user during the payment creation process. FIG. 3 is a flowchart illustrating in more detail an embodiment of the method for dynamic check generation according to the present invention. The method, via the processor 106, receives a new payment item from the user (301) and determines whether a static check image is indicated by the user (302). In this embodiment, the user may indicate a location of a static check image file during the payment creation process. To improve performance, when a location of a static check image file is defined, the system will not execute the check image generation class. The static check image thus will have higher precedence than the dynamic check image. The static check image association will be faster than the dynamic approach. In response to determine that a static check image is indicated by the user, the method, via the processor 106, retrieves the static check image (303), and displays the new payment item within the static check image (304). In response to determining that a static check image is not indicated, the method, via the processor 106, determines whether a check image generation class is configured (305). In this embodiment, a user may configure a check image generation class name with associated getter functions to obtain payment attributes and functions to dynamically generate the check image. In one embodiment, the check image generation class may be located at the shared library of a J2EE application. When a check image generation class is not configured, the method, via the processor 106, retrieves a preconfigured default check image (306) and displays the new payment item within the default check image (307). For example, the default check image may be an icon or a static graphic.

In response to determining that a check image generation class is configured, the method, via the processor 106, obtains the payment attributes from the user, using the getter function associated with the check image generation class (308). The method, via the processor 106, generates the check image using the payment attributes (309), and displays the new payment item within the check image (310). In this embodiment, the check image may be displayed as a front black and white image, a rear black and white image, or a front gray scale and rear gray scale image. Other image types may also be used.

The user may be allowed to modify the payment attributes and request a refresh of the check image. For example, a “Refresh” button may be displayed for the user to select to request the refresh. In response to determining that the check image is to be refreshed (311), the method, via the processor 106, obtains the modified check image generation information, i.e., the payment attributes (308), and regenerate the check image with the modified payment attributes (309). Optionally, the dynamically generated check image may be stored as the default check image for future payment items with the same payment attributes.

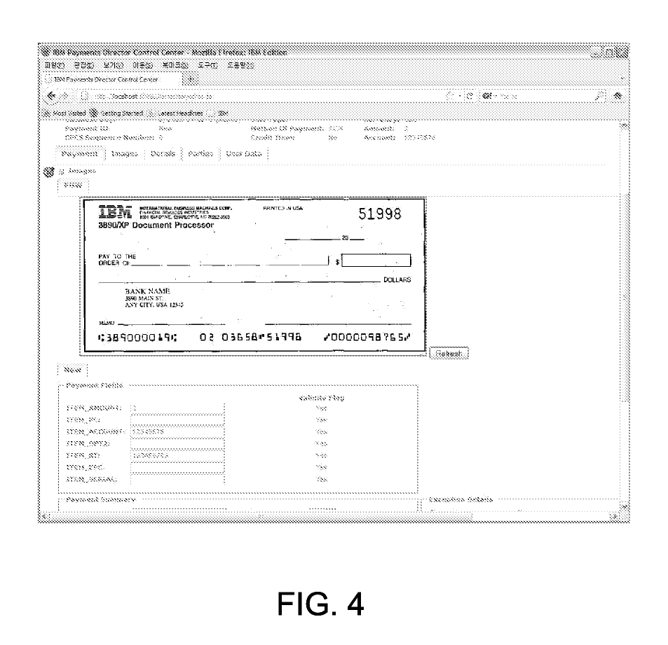

FIG. 4 illustrates an example screen that is generated according to an embodiment of the present invention. In the illustrated screen, the check image is dynamically determined based on the account number and routing transit number. The check image is repainted when the “Refresh” button is selected.

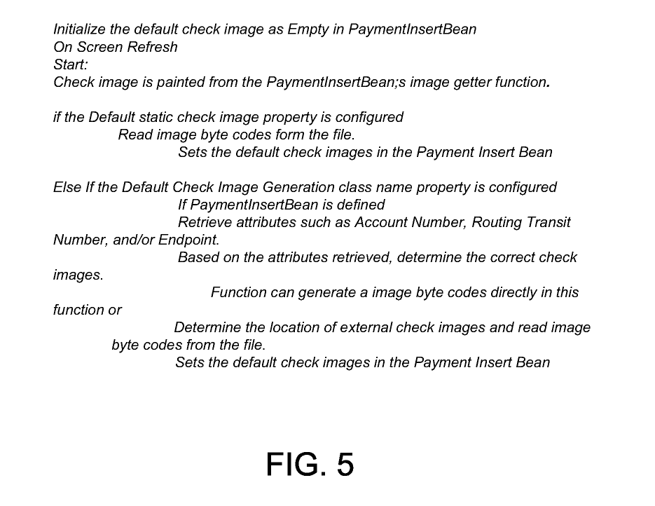

FIG. 5 illustrates a pseudo code segment according to an embodiment of the present invention. The input to the default check image generation process is the PaymentInsertBean object.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method implemented by a processor of computing device, comprising:
receiving, by the processor, a new payment item during a payment creation process;
in response to receiving the new payment item, determining whether a static check image for the new payment item is defined;
in response to determining that the static check image for the new payment item is not defined, determining whether a check image generation class for generating a dynamic check image is configured;
in response to determining that the check image generation class is configured, obtaining, during the payment creation process, one or more payment attributes for the new payment item using functions associated with the check image generation class;
generating, by the processor during the payment creation process, the dynamic check image using the payment attributes for the new payment item; and
displaying the new payment item within the dynamic check image.

2. (canceled)

3. The method of claim 1, further comprising:
determining a request to refresh the check image is received;
in response to determining that the request to refresh the check image is received, obtaining one or more modified payment attributes for the new payment item using getter functions associated with the check image generation class;
generating a modified dynamic check image using the modified payment attributes during the payment creation process; and
displaying the payment item within the modified dynamic check image.

4. The method of claim 1, wherein the determining whether the new check image generation class for generating the dynamic check image is configured comprises:
in response to determining that the static check image for the new payment item is defined, retrieving the static check image; and
displaying the new payment item within the static check image.

5. The method of claim 1, wherein the determining whether the new check image generation class for generating the dynamic check image is configured further comprises:
in response to determining that the check image generation class is not configured, retrieving a default check image; and
displaying the new payment item within the default check image.

6. A computer program product comprising:
a computer readable memory device having computer readable program code embodied therewith, the computer readable program code configured to:
receive a new payment item during a payment creation process;
in response to receiving the new payment item, determine whether a static check image for the new payment item is defined;
in response to determining that the static check image for the new payment item is not defined, determine whether a check image generation class for generating a dynamic check image is configured;
in response to determining that the check image generation class is configured, obtain, during the payment creation process, one or more payment attributes for the new payment item using functions associated with the check image generation class;
generate, during the payment creation process, the dynamic check image using the payment attributes for the new payment item during the payment creation process; and
display the new payment item within the dynamic check image.

7. (canceled)

8. The computer program product of claim 6, wherein the computer readable program code is further configured to:
determine a request to refresh the check image is received;
in response to determining that the request to refresh the check image is received, obtain one or more modified payment attributes for the new payment item using the getter functions associated with the check image generation class;
generate a modified dynamic check image using the modified payment attributes during the payment creation process; and
display the payment item within the modified dynamic check image.

9. The computer program product of claim 6, wherein the computer readable program code configured to determine whether the new check image generation class for generating the dynamic check image is configured is further configured to:
in response to determining that the static check image for the new payment item is defined, retrieve the static check image; and
display the new payment item within the static check image.

10. The computer program product of claim 6, wherein the computer readable program code configured to determine whether the new check image generation class for generating the dynamic check image is configured is further configured to:
in response to determining that the check image generation class is not configured, retrieve a default check image; and
display the new payment item within the default check image.

11. A system comprising:
a processor; and
a computer readable memory device having computer readable program code embodied therewith, the computer readable program code configured to:
receive a new payment item during a payment creation process;
in response to receiving the new payment item, determine whether a static check image for the new payment item is defined;
in response to determining that the static check image for the new payment item is not defined, determine whether a check image generation class for generating a dynamic check image is configured;
in response to determining that the check image generation class is configured, obtain, during the payment creation process, one or more payment attributes for the new payment item using functions associated with the check image generation class;
generate, during the payment creation process, the dynamic check image using the payment attributes for the new payment item during the payment creation process; and
display the new payment item within the dynamic check image.

12. (canceled)

13. The system of claim 11, wherein the computer readable program code is further configured to:
determine a request to refresh the check image is received;
in response to determining that the request to refresh the check image is received, obtain one or more modified payment attributes for the new payment item using getter functions associated with the check image generation class;
generate a modified dynamic check image using the modified payment attributes during the payment creation process; and
display the payment item within the modified dynamic check image.

14. The system of claim 11, wherein the computer readable program code configured to determine whether the new check image generation class for generating the dynamic check image is configured is further configured to:
in response to determining that the static check image for the new payment item is defined, retrieve the static check image; and
display the new payment item within the static check image.

15. The system of claim 11, wherein the computer readable program code configured to determine whether the new check image generation class for generating the dynamic check image is configured is further configured to:
in response to determining that the check image generation class is not configured, retrieve a default check image; and
display the new payment item within the default check image.

16-19. (canceled)
